(19) United States
(12) Patent Application Publication
(10) Pub. No.: US 2006/0267400 A1
(43) Pub. Date: Nov. 30, 2006

(54) Assembled wheel structure

(76) Inventor: Huei-Wen Cheng, Taoyuan (TW)

Correspondence Address: TROXELL LAW OFFICE PLLC;Suite 1404, 5205 Leesburg Pike, Falls Church, VA, 22041, US

(21) Appl. No.: 11/156,771

(22) Filed: Jun. 21, 2005

(30) Foreign Application Priority Data
May 31, 2005 (TW) 94208965

(51) Int. Cl. B60B 35/16

(52) U.S. Cl. 301/137

(57) ABSTRACT

An assembled wheel structure is constructed of a base, a main body, and-an outwardly protrudent plate. The base is fixed on bottom edges of a traveling bag. The base comprises a first main plate and a reception bracket, wherein the reception bracket has a first reception trench. A first insertion plate and a first fastening device are mounted on both ends of the first main plate, respectively. The main body comprises a second main plate and a wheel bracket, wherein a second insertion plate and a second fastening device are mounted on both ends of the second main plate, respectively. The second insertion plate is inserted into the second reception trench formed between the outwardly protrudent plate and the first main plate. The first and second main plates can be fastened together or detached from one another without the use of any tool.

### FIELD OF THE INVENTION

The present invention is related to an assembled wheel structure, and more particularly to an assembled wheel structure of a traveling bag with dual purposes of being carried on the back and held by hand. The assembled wheel structure of the present invention is of two-piece design. It can be conveniently, rapidly detached or replaced at any time without the use of any tool. The convenience in attachment and detachment is achieved by avoiding the conventional obstruction caused by the protrudent wheel when it is carried on the back and protecting it from being damaged during the carry.

### BACKGROUND OF THE INVENTION

The conventional large-sized traveling bag with wheel structure usually equips with straps for being carried on the back and a retractable pull rod simultaneously for pulling and dragging. As a result, the user can choose a suitable, labor-saving carry way according to the practical loading weight.

Nevertheless, because of being fixed on the traveling bag through rivets, the entire wheel structure must be disassembled so as to maintain and replace the wheel when it is slipped on the ground for a long period or damaged by collision in the carry. As a matter of fact, this kind of maintenance process is difficult for most people. Moreover, once being carried on the back, the protrudent wheel on one side of the traveling bag is not pleasing to the eye and also indirectly becomes redundant for the user. As a result, there is a need to develop a structure for overcoming the shortcoming of the existing wheel structure and facilitating its attachment and detachment.

### SUMMARY OF THE INVENTION

It is a main object of the present invention to provide an assembled wheel structure, which is of two-piece design. The main body is coupled with the base depending on practical application such as pulling or dragging. The main body can be detached to avoid the obstruction caused by the protrudent wheel when it is carried on the back or prevent it from being damaged by collision when it is held.

It is another object of the present invention to provide an assembled wheel structure with a detachable and replaceable wheel. If the wheel is slipped on the ground for a long period or damaged by collision of exterior article, the wheel can be conveniently, rapidly replaced alone. The economic benefits in saving time, labor, and money are achieved since it is not necessary to laboriously disassemble the entire wheel structure.

Other objects and features of the present invention will become apparent from the following detailed description when taken in conjunction with the drawings in which:

### BRIEF DESCRIPTION OF THE DRAWINGS

FIG. 1 is an elevational view of the present invention.

FIG. 2 is an exploded view of the present invention.

FIG. 3 is a schematic view showing that the base is coupled to the outwardly protrudent plate in accordance with the present invention.

FIG. 4 is a cross-sectional view of FIG. 1.

FIG. 5 is a schematic view showing a preferred embodiment of the present invention.

FIG. 6 is a schematic view showing another preferred embodiment of the present invention.

FIG. 7 is a schematic view showing a further preferred embodiment of the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

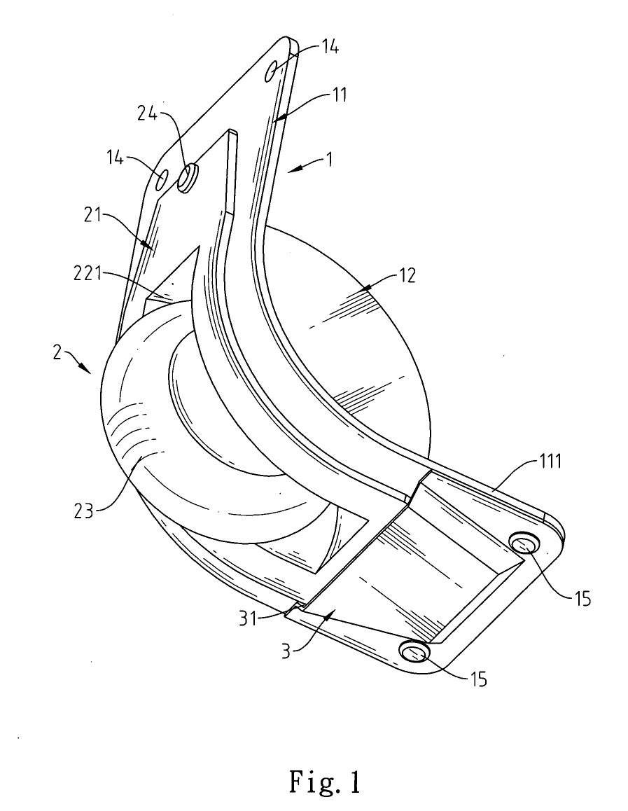

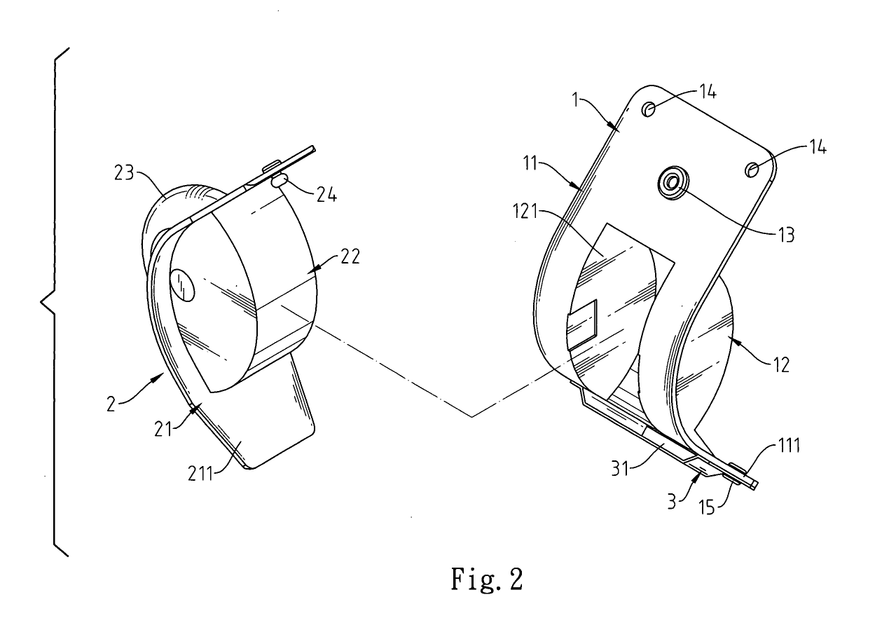

Referring to FIG. 1 through FIG. 3 and FIG. 5, an assembled wheel structure of the present invention comprises a base 1, a main body 2, and an outwardly protrudent plate 3. The base 1 is composed of a main plate 11 and a reception bracket 12, wherein the reception bracket 12 is mounted on the center of the main plate 11 and provided with an arc-shaped reception trench 121. The main plate 11 is in a shape of arc. An insertion plate 111 is mounted on one end of the main plate 11, and a first fastening device 13 is mounted on the other end of the main plate 11 opposite to the insertion plate 111. Several insertion holes 14 are formed on four corners of the main plate 11 for fixing it on bottom edges of a traveling bag 10 by use of several locking devices 15.

The main body 2 comprises a main plate 21 and a wheel bracket 22. For the purpose of insertion of the wheel bracket 22 into the reception trench 121, the main plate 21 is in a shape conformal to that of the main plate 11 of the base 1, wherein an insertion plate 211 is mounted on one end of the main plate 21 and a second fastening device 24 is mounted on the other end of the main plate 21 corresponding to the first fastening device 13. In absence of any tool, if the wheel bracket 22 is inserted into the reception trench 121, the main plate 11 and the main plate 21 can be conveniently, rapidly fastened together by pressing the fastening devices directly. A semi-spherical wheel trench 221 is formed on the wheel bracket 22 for pivotally mounting a wheel 23.

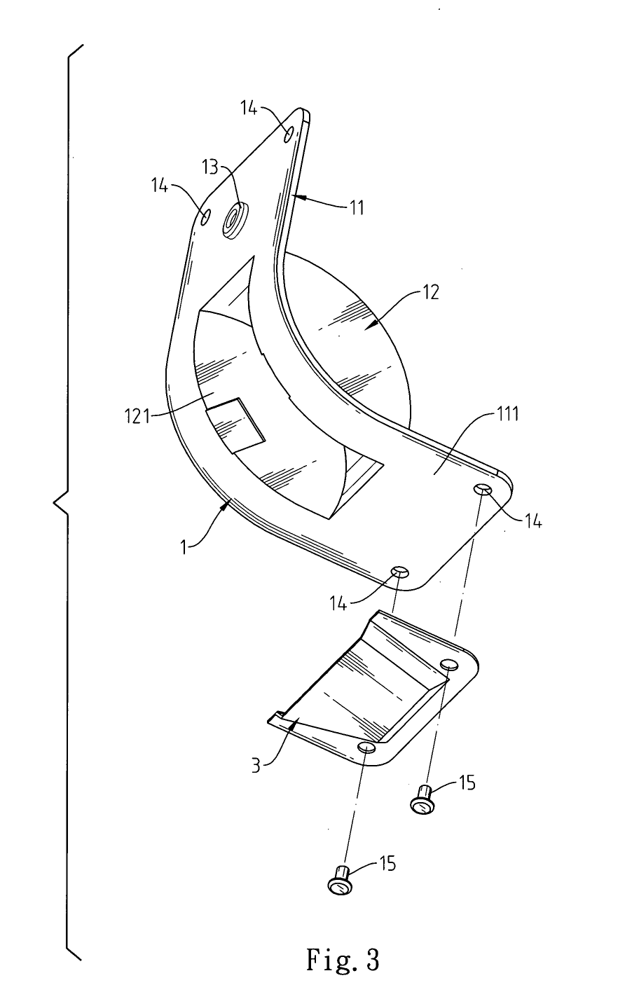

The outwardly protrudent plate 3 is made of wear-resisting material. As shown in FIG. 3, the outwardly protrudent plate 3 is mounted on the other end of the main plate 11 of the base 1 opposite to the first fastening device 13 for forming a reception trench 31 between the main plate 11 and the outwardly protrudent plate 3, wherein an opening of the reception trench 31 is located to face the first fastening device 13.

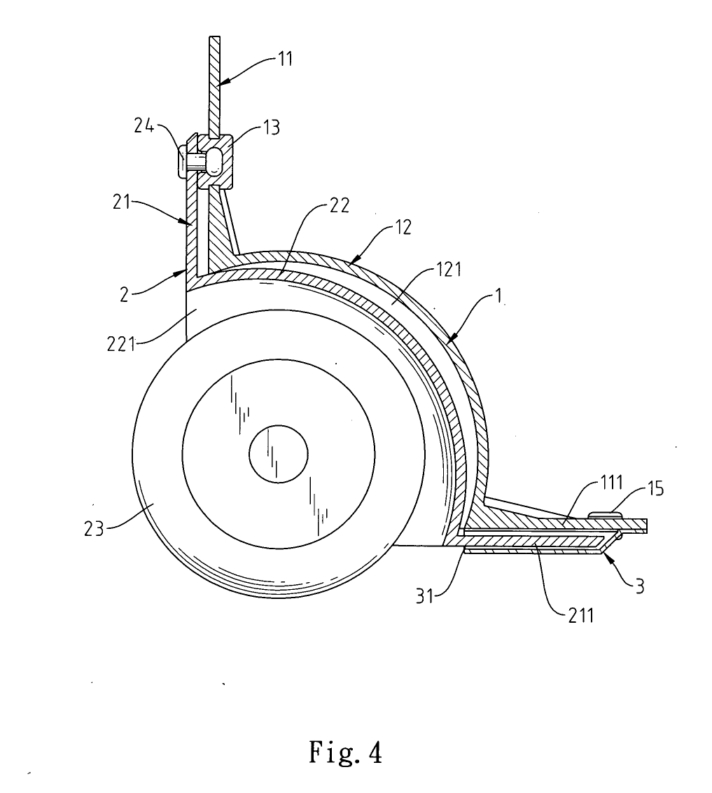

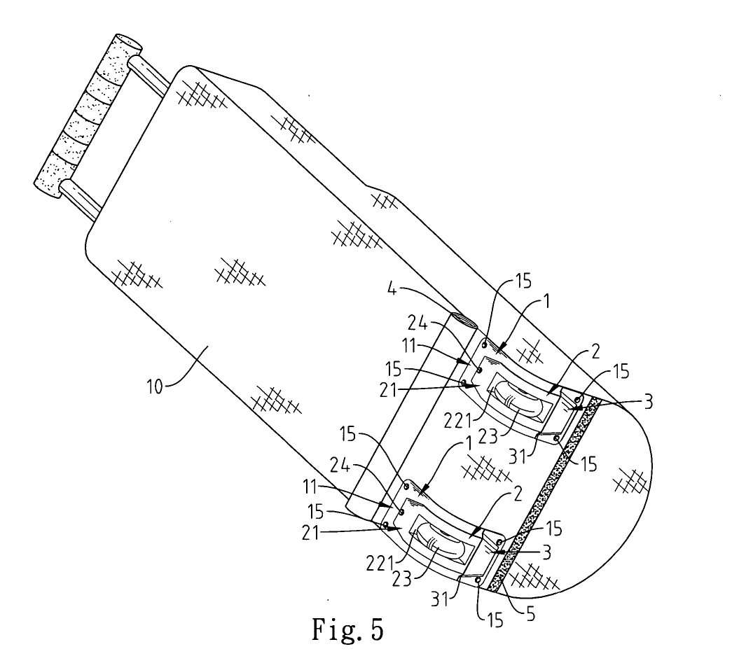

Referring to FIG. 4 and FIG. 5, the assembled wheel structure of the present invention is mounted on the bottom edges of the traveling bag 10. The traveling bag 10 may be stably mounted on the ground by use of the assembled wheel structure. For the purpose of moving, the traveling bag 10 is tilted in an angle so as to enable the wheel 23 to touch the ground. Thus, the user is capable of shifting the traveling bag 10 in a more labor-saving manner. For the purpose of positioning, the outwardly protrudent plate 3 is mainly designed for easily, rapidly inserting the main body 2 into the base 1. In addition, the outwardly protrudent plate 3 can protect the main plate 21 of the main body 2 from contacting the ground directly so as to extend its lifetime.

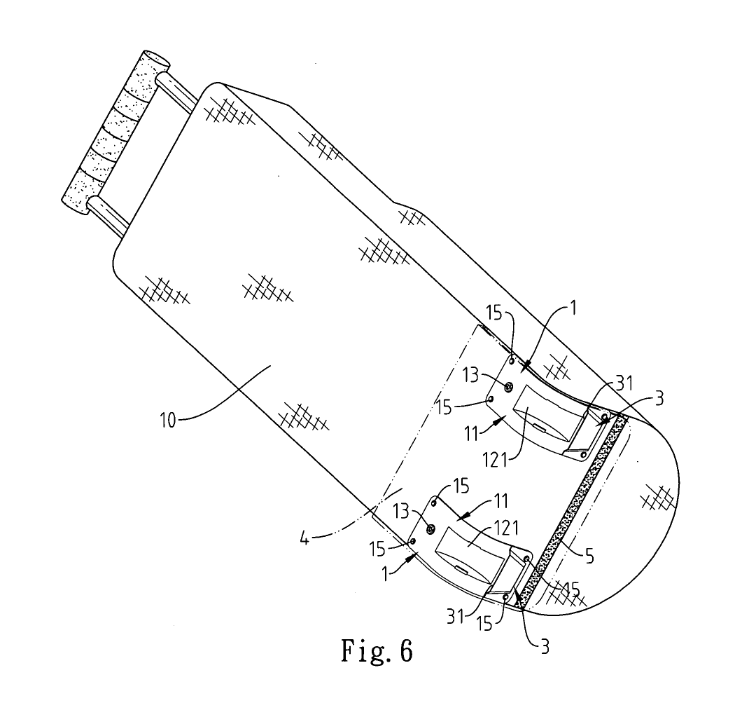

Referring further to FIG. 5 and FIG. 6, the assembled wheel structure of the present invention is of two-piece design, which is constructed of coupled base 1 and main body 2, wherein the base 1 is fixed on the bottom edges of the traveling bag. Besides, the main body 2 is coupled with the base 1 depending on practical situation, in which the insertion plate 21 on one end of the main body 2 is inserted into the reception trench 31. When the wheel bracket 22 inserts into the reception trench 121, the second fastening device 24 on the other end of the main body 2 locks the first fastening device 13. Thus, the main plate 11 and the main plate 21 can be fastened together conveniently and rapidly for further coupling the base 1 with the main body 2 without the use of any tool, as shown in FIG. 5. Furthermore, in order to avoid the obstruction caused by the protrudent wheel 23 when the traveling bag is carried on the back or prevent the wheel from being damaged by collision of exterior article when it is held, the main body 2 can be disassembled in a reverse direction in accordance with the assembling method mentioned above, as shown in FIG. 6. Besides, a Velcro layer 5 is mounted on the traveling bag 10 around the base 1. For the purpose of pretty appearance and dust-proof effect, a protection layer 4 is then attached to the Velcro layer 5 for covering the base 1 when the main body 2 is detached from the base 1.

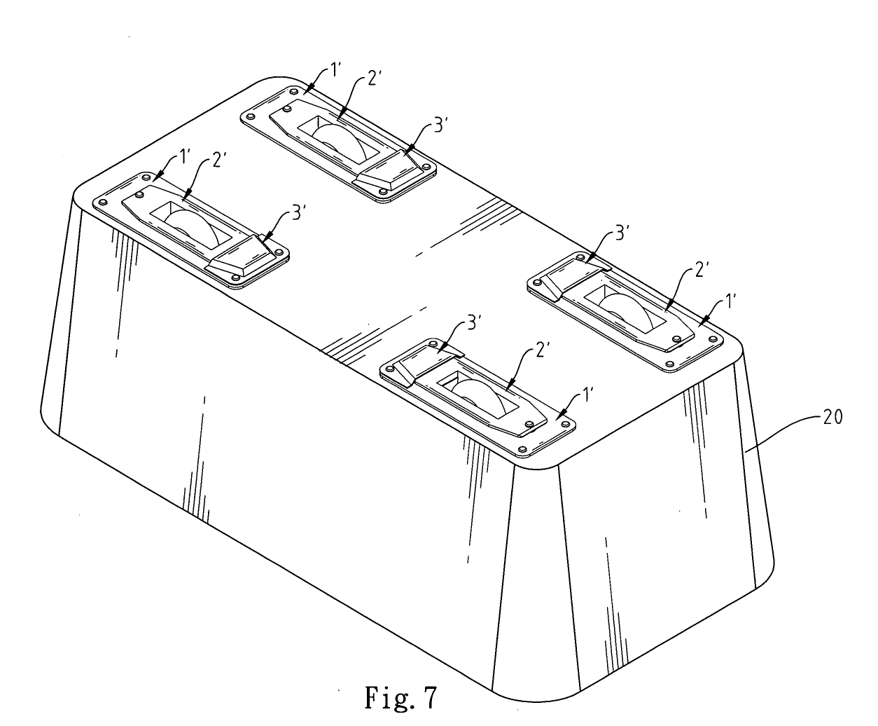

Referring further to FIG. 7, the base 1′ and the main body 2′ of the assembled wheel structure of the present invention may be flat such that the base 1′, the main body 2′, and the outwardly protrudent plate 3′ jointly form a plane surface. Accordingly, instead of being mounted on the edges of an article, for example, a storage box 20, a wagon, etc., the assembled wheel structure can be fixed on the bottom of the article for facilitating the moving and shifting of the article. Consequently, the assembled wheel structure of the present invention can be mounted on the traveling bag 10, but not limited thereto.

While the preferred embodiment of the invention has been set forth for the purpose of disclosure, modifications of the disclosed embodiment of the invention as well as other embodiments thereof may occur to those skilled in the art.

What the invention claimed is:

1. An assembled wheel structure, comprising:
a base fixed on bottom edges of a traveling bag, the base comprising a first main plate and a reception bracket, the reception bracket being mounted on the center of the first main plate and having an arc-shaped first reception trench, a first insertion plate being mounted on one end of the first main plate, and a first fastening device being mounted on the other end of the first main plate opposite to the first insertion plate;
a main body comprising a second main plate and a wheel bracket, the wheel bracket being inserted into the first reception trench of the base, the wheel bracket having a semi-spherical wheel trench for pivotally mounting a wheel, a second insertion plate being mounted on one end of the second main plate, and a second fastening device being mounted on the other end of the second main plate opposite to the second insertion plate; and
an outwardly protrudent plate mounted on the other end of the first main plate opposite to the first fastening device for forming a second reception trench between the first main plate and the outwardly protrudent plate, the second reception trench having an opening facing the first fastening device, wherein
the second fastening device and the first fastening device are fastened together to fixedly assemble the main body to the base by inserting the second insertion plate into the second reception trench, and the main body is detachable from the base.

2. The assembled wheel structure of claim 1, further comprising a Velcro layer mounted on the traveling bag around the base, wherein a protection layer is attached to the Velcro layer for covering the base when the main body is detached from the base.

3. The assembled wheel structure of claim 1, wherein the first main plate of the base is in a shape conformal to that of the second main plate of the main body.

4. The assembled wheel structure of claim 1, wherein the first main plate of the base and the second main plate of the main body are flat.
